(19) United States
(12) Patent Application Publication
(10) Pub. No.: US 2011/0181516 A1
(43) Pub. Date: Jul. 28, 2011

(54) TOUCH-SCREEN CONTROL PANEL FOR A DISHWASHER

(75) Inventors: Lucas Mallory, Crestwood, KY (US); Joseph Duane Tobbe, Taylorsville, KY (US); Adam Hofmann, Louisville, KY (US); Masud Chowdhury, Louisville, KY (US); Suryanarayana Murthy Atreyapurapu, Andhrapradesh (IN)

(73) Assignee: General Electric Company

(21) Appl. No.: 12/692,025

(22) Filed: Jan. 22, 2010

(51) Int. Cl. G06F 3/041; B29C 45/14; E06B 3/00

(52) U.S. Cl. 345/173; 264/104; 49/507

(57) ABSTRACT

A touch-screen interface for a dishwasher door comprises a user interface, a touch sensitive component and a holder. The user interface includes a graphics film defining a plurality of transparent portions. The user interface is configured to facilitate touch communication therethrough. The graphics film is secured to the user interface to prevent moisture therebetween. The touch sensitive component is configured to receive touch communication through the user interface. The touch sensitive component senses a position of a user's finger on the user interface. The holder is releasably connected to the user interface and is configured to releasable secure the touch sensitive component to the user interface. The holder is releasably coupled to a dishwasher door. The releasable connection between the components of the touch-screen interface allows for ease of disassembly and repair or replacement of the components.

### BACKGROUND

Exemplary embodiments herein generally relate to washing appliances and, more particularly, to a touch-screen control panel for a dishwasher.

Washing appliances, such as dishwashers, typically include a control panel operably engaged with an upper portion of a front door member such that a user may easily access the control panel. Conventional dishwashers may particularly include control panels having mechanical switches and/or flexible membrane switches that may be sealed from the relatively wet environment around the dishwasher.

As is well known, “touch-screen” user interfaces are displays that have the ability to detect the location of touches within a display area. This allows the display to be used as an input device, removing physical buttons as the primary input device for interacting with the display's content. While many modern electronic devices and electrical appliances utilize “touch-screen” user interfaces for convenience, durability, and pleasing aesthetic properties, such control interfaces are generally not used for dishwashers and/or other “wet” washing appliances due to the difficulties in providing a substantially fluid-tight arrangement about the touch-screen interface such that the user interface may remain robust and operable in an excessively wet environment.

### BRIEF DESCRIPTION

According to one aspect, a touch-screen interface for a dishwasher door comprises a user interface, a touch sensitive component and a holder. The user interface includes a graphics film defining a plurality of transparent portions. The user interface is configured to facilitate touch communication therethrough. The graphics film is secured to the user interface to prevent moisture therebetween. The touch sensitive component is configured to receive touch communication through the user interface. The touch sensitive component senses a position of a user's finger on the user interface. The holder is releasably connected to the user interface and is configured to releasable secure the touch sensitive component to the user interface. The holder is releasably coupled to a dishwasher door. The releasable connection between the components of the touch-screen interface allows for ease of disassembly and repair or replacement of the components.

According to another aspect, a method for forming a touch-screen interface for a dishwasher door comprises providing an in-mold graphics film. The in-mold graphics film defines a plurality of transparent portions. A user interface is coupled with the in-mold graphics film such that the in-mold graphics film is integral with the user interface and the plurality of translucent portions extend through a thickness of the user interface. A touch sensitive component is positioned proximate to the user interface such that the touch sensitive component is capable of receiving touch communication through the user interface. A holder is releasably connected to the user interface. The holder is configured to receive the touch sensitive component.

According to yet another aspect, a dishwasher door comprises a door structure and a touch-screen interface coupled to the door structure. The touch-screen interface includes an in-mold graphics film defining a plurality of transparent portions. A user interface is coupled with the in-mold graphics film such that the in-mold graphics film is integral with the user interface and the plurality of translucent portions extend through a thickness of the user interface. A touch sensitive component is coupled to the user interface. The touch sensitive component is capable of receiving touch communication through the user interface. The thickness of the user interface prevents inadvertent activation of the touch sensitive component. A holder is releasably connected to the user interface. The holder is configured to receive the touch sensitive component. A controller is releasably housed within the holder. The controller is in communication with the touch sensitive component to interpret a user's selection on the user.

### BRIEF DESCRIPTION OF THE DRAWINGS

FIG. 1 is an exploded perspective view of a touch-screen control panel for a dishwasher according to one aspect of the present disclosure.

FIG. 2 is a partial cross-sectional view of a user interface of the touch-screen control panel of FIG. 1 taken generally along line 2-2 of FIG. 1.

FIG. 3 is an exploded perspective view of a touch-screen control panel for a dishwasher according to another aspect of the present disclosure.

FIG. 4 is an exploded view of a user interface of the touch-screen control panel of FIG. 3.

FIG. 5 is a partial cross-sectional view of the user interface of FIGS. 3 and 4 taken generally along line 5-5 of FIG. 3.

### DETAILED DESCRIPTION

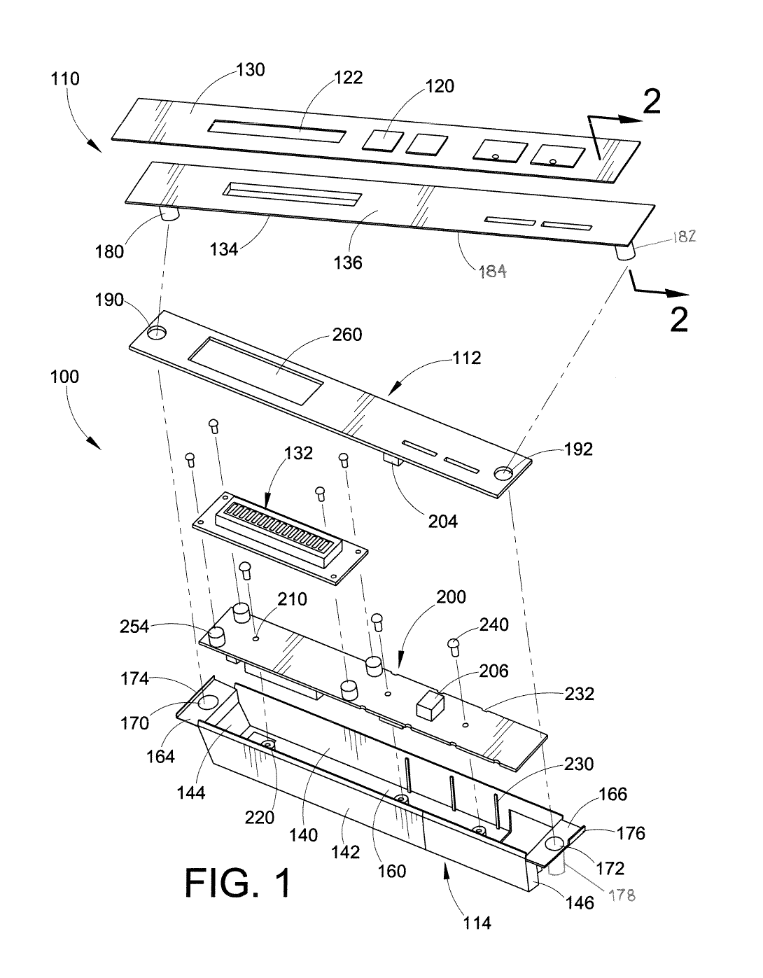

It should, of course, be understood that the description and drawings herein are merely illustrative and that various modifications and changes can be made in the structures disclosed without departing from the present disclosure. Referring now to the drawings, wherein like numerals refer to like parts throughout the several views, FIG. 1 depicts a touch-screen interface or control panel 100 adapted to be operably engaged with or about a top portion of a door structure of a dishwasher according to one aspect of the present disclosure. The touch-screen interface generally comprises a user interface 110, a touch sensitive component 112 configured to receive touch communication through the user interface and an escutcheon or holder 114 releasably connected to the user interface 110 and configured to releasable secure the touch sensitive component 112 to the user interface. It should be appreciated that the releasable connection between the components 110, 112, 114 of the touch-screen interface 100 allows for ease of disassembly and repair or replacement of the components.

As shown in FIG. 1, the user interface 110, which is configured to facilitate touch communication therethrough, includes a plurality of transparent portions 120 that are disposed generally adjacent to a plurality of touch-responsive surfaces (not shown) of the touch sensitive component 112 which are accessible to a user of the dishwasher via the user interface. As will be discussed in greater detail below, the touch sensitive component 112 is fluidly isolated from the moist environment of the dishwasher and can be actuated by touching the user interface 110. The user interface 100 includes a graphics film 130 which defines the plurality of transparent portions 120. Each of the plurality of transparent portions 120 may be formed to include or otherwise represent pictograms, symbols, and/or alphanumeric indicia that may be generally indicative of the functions of the various touch-responsive surfaces associated with the control panel 100. In some embodiments, the plurality of transparent portions 120 may also comprise a display window 122 configured and/or positioned such that an informational and/or alphanumeric display 132 of the control panel 100 may be visible to a user of the dishwasher via the display window 122.

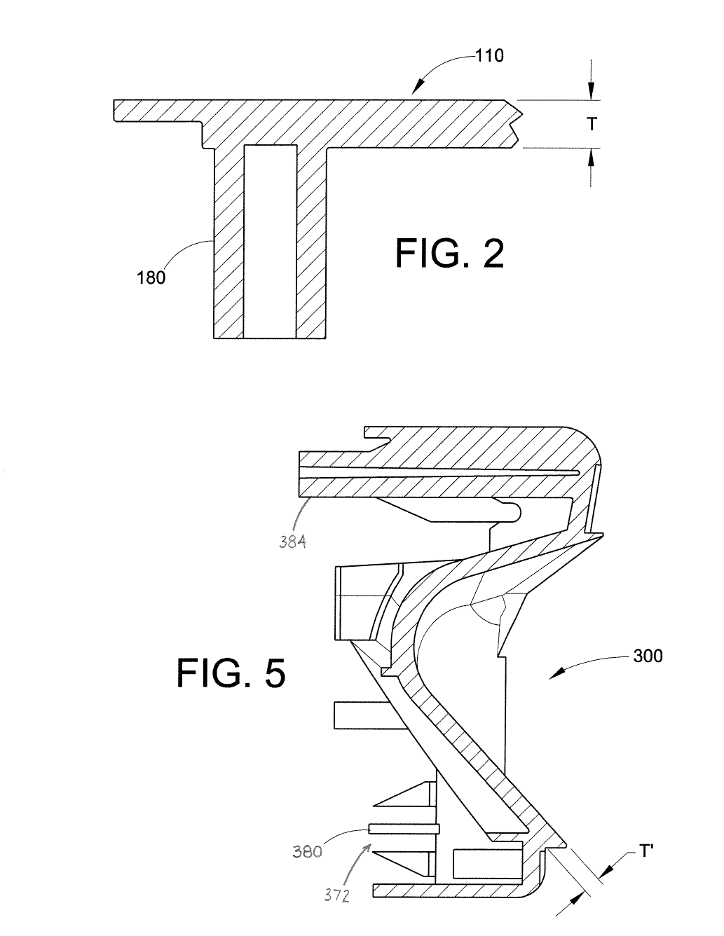

The graphics film 130 is secured to a body 134 of the user interface 110 so as to restrict passage of fluid therebetween. In the illustrated exemplary embodiment, the graphics film 130 is attached to a top surface 136 of the body 134 of the user interface 110. More particularly, the user interface 110 including the graphics film 130 are molded together as a unitary component. The user interface 110 can be formed by inserting an in-mold (IMD) graphics film into a polymer injection mold that is sized and/or configured to form the user interface 110. Molten polymeric material is subsequently injected into that mold. The polymer is used to form the body 134 of the user interface 110 about the graphics film 130 such that the plurality of transparent portions 120 extend through a thickness T (FIG. 2) of the user interface 110. To form the transparent portions, according to one exemplary embodiment, colored polymer (black or white) is used to form the body 134. The body included openings which are aligned with portions of the graphics film 130 where no ink was applied. This combination allows for light from at least one LED located on the touch sensitive component 112, for example, to shine through the body 134 as well as the graphics film 130. According to another exemplary embodiment, a clear polymer is used to form the body 134 so that only LEDs located on the touch sensitive component 112 need to be aligned with non-ink portions of the graphics film 130. No openings in the body are required. With both constructions, there are no holes in the graphics film 130. The graphics film 130 determines the locations and/or the various shapes or symbols associated with the transparent portions 120 defined in the user interface 110. The user interface 110 and the graphics film 130 may be formed of a variety of polymer materials that may be suited for injection molding and/or other polymer forming processes.

Referring again to FIG. 1, the user interface 110 is releasably connected to the holder 114, which is releasably coupled to the dishwasher door structure. In the depicted exemplary embodiment, the holder 114 is generally rectangular shaped and includes first and second opposed side walls 140, 142 and first and second opposed end walls 144, 146. The side walls and the end walls are connected to a base 160. Located on an upper portion of each end wall 144, 146 is an outwardly extending flange 164, 166. Each flange includes an opening 170, 172 and a shoulder 174, 176. Bosses (only boss 178 is visible) are provided on the flanges 164, 166 below the openings 170, 172. To mount the user interface 110 to the holder 114, a pair of bosses 180, 182 is provided on a bottom surface 184 of the body 134 of the user interface. In the depicted embodiment of FIG. 2, the bosses 180, 182 are integrally formed with the body 134. The bosses 180, 182 are positioned in the openings 170, 172 located in the flanges 164, 166 and through the bosses 178. Once positioned within the openings, ends portions of the user interface 110 sit on the flanges 164, 166 between the shoulders 174, 176. Conventional fasteners, such as screws (not shown), can be used to engage the bosses 180, 182 from a bottom of the holder 114. When each screw is completely tightened, the screw head is in contact with the bottom of the holder boss. This holds the body 134, the circuit board 112, and the holder 114 all together in one assembly. The holder 114 can be formed by injection molding; although, alternative methods for making the holder are contemplated.

The touch sensitive component 112 is positioned between the user interface 110 and the holder 114. The touch sensitive component is configured to sense a position of a user's finger on the user interface 110. According to one exemplary embodiment, the touch sensitive component 112 is a capacitive touch board having conductive traces on it that can sense the position of a user's finger on the top side of the graphics film 130. The traces are generally aligned with the transparent portions 120 defined in the user interface 110. Thus, the capacitive touch board is capable of being activated by capacitively coupling with a conductive touch object such as the user's finger. According to one aspect, the conductive traces can define discrete touch sensors, each touch sensor having active areas defining where a touch can be applied to the surface of the user interface 110 to activate the respective touch sensor. As indicated previously, these active areas can be designated by various shapes or symbols associated with the transparent portions 120 to give the user visual indicia for locating the sensors, for indicating the function(s) controlled by the sensors, and/or for indicating how to use the sensors. It should be appreciated that the user interface 110 can be at least partially light transmissive and the touch sensitive component 112 can include a light-emitting element capable of emitting light, such that the light is visually perceptible through the user interface.

As with other capacitive touch boards, capacitive coupling can be measured by measuring current that flows through a completed circuit. At a predetermined or calibrated level of capacitive coupling, the touch sensor can be considered “pressed,” allowing a “button down” signal to be sent. When the measured capacitive coupling falls below the threshold, a “button up” signal can be sent. In this way, a user can interact with the button sensor in a manner analogous to interaction with a mechanical button. In addition to conductive traces, the discrete touch sensors can be defined by any suitable conductor, such as a conductive foil on the touch sensitive component 112 to cover the designated area defined by each transparent portion 120, a conductive ink or other such material printed or coated on the touch sensitive component 112 to cover the designated area, a series of wires disposed to cover the designated area, or the like.

The user interface 110 including the graphics film 130 minimizes dimensional tolerances for proper operation of the touch-screen interface 100. In the exemplary embodiment, and as shown in FIG. 2, the portion of the body 134 of the user interface 110 that includes the graphics film 130 has a substantially constant, predetermined thickness T for preventing inadvertent activation of the touch sensitive component 112, such as by, for example, a user's finger being in close proximity to the user interface 110. According to one aspect, the thickness T of the user interface 110 including the graphics film 130 is about 0.115 inches to about 0.125 inches in the area of the touch-responsive surfaces of the touch sensitive component 112. To further prevent accidental activation of the touch sensitive component 112, the sensitivity of the touch sensors can be set so that the user's finger would have to actually come in contact with the user interface 110 in order for a control board (such as controller 200) to read that action as a valid “button” press. Also, if multiple adjacent “buttons” on the user interface 110 were pressed at the same time (i.e. someone leans on the user interface with their palm), then the controller would interpret that as an invalid action, and no buttons would be activated in that case.

As indicated previously, the touch sensitive component 112 is positioned beneath the user interface 110 and is at least partially housed by the holder 114. To mount the touch sensitive component 112 to the user interface 110, ends of the touch sensitive component include openings 190, 192. The openings are dimensioned to receive the bosses 180, 182 which are secured within the openings 170, 172 located in the flanges 164, 166 of the holder 114. The capacitive touch board 112 is connected to the touch sensitive component 112. According to one exemplary embodiment, the capacitive touch board 112 is suitably sealed to a bottom surface of the user interface 110, such as by an adhesive or double-sided adhesive tape, to prevent the presence of moisture between the user interface 110 and the touch sensitive component 112.

The touch-screen interface 110 further includes the controller 200, which is releasably coupled to the holder 114. The controller is in communication with the touch sensitive component 112 to interpret a user's selection on the user interface 110 and is in communication with a main controller (not shown) of the dishwasher. More particularly, and as indicated previously, the exemplary capacitive touch board 112 can be provided with conductive traces to sense the position of a user's finger on the top side of the graphics film 130. The conductive traces can be connected to a connector 204 located on the capacitive touch board, which would be coupled to a connector 206 located on the controller 200. In the depicted embodiment, the controller 200 is housed within the holder 114. To mount the controller 200 to the holder 114, the controller includes apertures 210, which when the controller is properly positioned within the holder, are aligned with spaced apart bosses 220 provided on the base 160. To ensure proper alignment, at least one side wall 140, 142 includes at least one elongated ridge which is oriented perpendicular to the base 160. The controller 200 includes at least one notch for receiving the at least one elongated ridge 230. As shown, the side wall 140 include three spaced apart ridges 230 and the controller includes three corresponding notches 232; although, this is not required. The engagement of each ridge 230 within each notch 232 properly positions the controller 200 within the holder 114 for ease of assembly. Conventional fasteners, such as screws 240, can then extend through the apertures 210 and threadingly engage the bosses 220.

With continued reference to FIG. 1, the touch-screen interface 100 can further include the digital display 132. The digital display 132 is releasably connected to the controller 200 via bosses 254 located on the controller. At least a portion of the digital display is received in an opening 260 located on the touch sensitive component 112. The digital display 132 is in communication with the controller 200 and communicates to the user through the user interface 110 in response to the user activating the touch sensitive component 112.

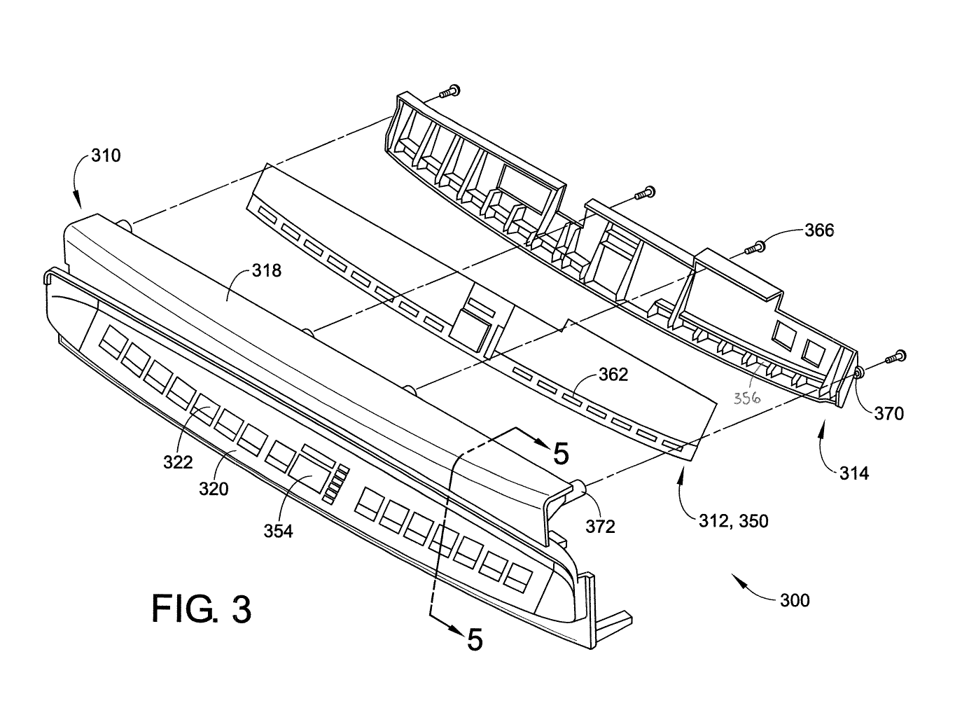

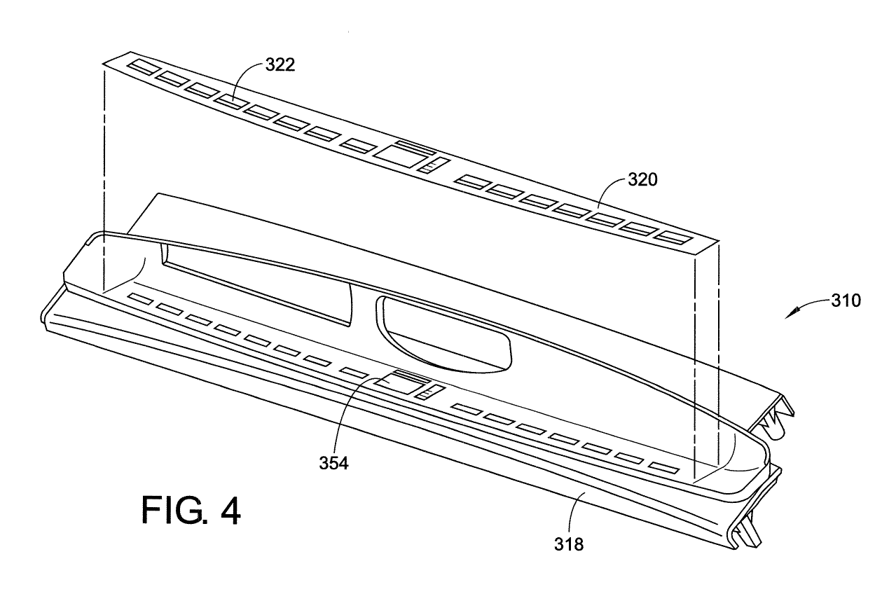

With reference now to FIGS. 3 and 4, a touch-screen interface or control panel 300, according to another aspect of the present disclosure, is depicted. The control panel 300 is adapted to be operably engaged with or about a top portion of a door structure of a dishwasher. Similar to touch-screen interface 100, the touch-screen interface 300 includes a user interface 310, a touch sensitive component 312 connected to the user interface 310, and a holder 314 releasably connected to the user interface 310 and configured to receive the touch sensitive component 312. Similar to the previous exemplary embodiment, the touch sensitive component 312 can be suitably sealed to the user interface 310 to restrict passage of fluid and/or prevent moisture therebetween.

The user interface 310 includes a body 318 and an in-mold graphics film 320 defining a plurality of transparent portions 322. The body 318 of the user interface is coupled with the in-mold graphics film 320 such that the in-mold graphics film is integral with the body and the plurality of translucent portions 322 extend through a thickness of the user interface 310. According to one aspect, colored polymer (white or black) is used to form the body 318. Openings are provided on the body to allow light from at least one LED located on the touch sensitive component 312 to shine through non-ink portions of the graphics film 320. No holes are provided on the graphics film. As shown, a portion of the user interface 310 with the graphics film 320 has a generally concave configuration. The touch sensitive component 312 is capable of receiving touch communication through the user interface 310. Again, the user interface 310 including the graphics film 320 minimizes dimensional tolerances for proper operation of the touch-screen interface 300. The portion of the body 318 that includes the graphics film 320 has a substantially constant, predetermined thickness T′ (FIG. 5) for preventing inadvertent activation of the touch sensitive component 312. In the exemplary embodiment, and as shown in FIG. 5, a thickness of that portion of the user interface 310 including the graphics film 320 is about 0.145 inches to about 0.155 inches in the area of touch-responsive surfaces of the touch sensitive component 312.

One of the benefits of minimizing dimensional tolerances is that the combination of the injection molded body 318 with the graphics in-mold decorated film 312 provides a very constant thickness over the entire surface of the user interface 310 compared to other designs that includes a “peel-and-stick” graphics layer. This “peel-and-stick” layer introduces a large amount of variance in material thickness that has to be incorporated into the tolerances for button sensitivity to prevent inadvertent activation. The touch-responsive surfaces of the touch sensitive component 312 are designed for optimal operation with the thickness of the user interface 310. The material thickness of the user interface is an important factor when designing the performance of the touch-responsive surfaces of the touch sensitive component 312. The geometry of the touch-responsive surfaces is set according to the thickness of the user interface 310. According to the present disclosure, the touch sensitive component 312 and user interface have a substantially constant, predetermined thickness in order to set the overall system performance to match the desired feel of button activation, to minimize unintentional button activation when the user is cleaning the graphics surface, and to minimize “cross-talk” between buttons so that the only button that is activated is the button that the user touches instead of activation of adjacent buttons.

The touch-screen interface 300 further includes a controller 350 releasably connected to the holder 314. The controller is in communication with the touch sensitive component 312 to interpret a user's selection on the user. In the depicted exemplary embodiment, the touch sensitive component 312 is a capacitive touch board which also includes the operational components of the controller 350. Thus, the touch sensitive component 312 and the controller 350 is a unitary component.

With continued reference to FIG. 3, the touch-screen interface 300 can further include a digital display (not shown). The digital display can be releasably connected to the user interface 310. At least a portion of the digital display is received in an opening 354 located on the user interface. The digital display is in communication with the controller 350 and communicates to the user through the user interface 310 in response to the user activating the touch sensitive component 312. It should be appreciated that light-emitting elements (not shown) can be operatively connected to the touch sensitive component 312. Because the touch sensitive component 312 can be suitably sealed to the user interface 310, the light-emitting elements are positioned between the touch sensitive component 312 and the holder 314. The light-emitting elements emit light towards reflective portions 356 located on the holder 314. The reflective portions redirect the light through openings 362 located on the touch sensitive component 312. In this manner, the light is visually perceptible through the translucent portions 322 of the user interface 310.

To assemble the touch-screen interface 300, the touch sensitive component 312 is connected to the user interface. As indicated previously, according to one aspect, the touch sensitive component 312 is sealed to the user interface 310 to prevent presence of moisture therebetween. By way of example only, to seal the touch sensitive component 312 to the user interface 310, double-sided adhesive tape can be applied to the touch sensitive side of the component 312 and the back side of the user interface 310 or a gasket can be positioned between the touch sensitive side of the component 312 and the back side of the user interface 310 or the component 312 can be pressed firmly against the back side of the user interface 310. The holder 314 is then releasably connected to the user interface via conventional fasteners, such as screws 366, which extend through openings 370 located on the holder and threadingly engage bosses 372 located on the user interface 310. As shown in FIG. 5, the bosses 372 include spaced apart gussets 380 to add strength and stability to the bosses. Although, it should be contemplated that alternative manners of releasably securing the component of the touch-screen interface 300 together are contemplated. Separate bosses 384 are provided on the user interface 310 for releasably mounting the touch-screen interface 300 to a dishwasher door structure.

As is evident from the foregoing, an exemplary method for forming a touch-screen interface 100, 300 for a dishwasher door structure is provided. The method generally comprises providing an in-mold graphics film 130, 320. The in-mold graphics film defines a plurality of transparent portions. A user interface 110, 310 is coupled with the in-mold graphics film such that the in-mold graphics film is integral with the user interface and the plurality of translucent portions extend through a thickness of the user interface. The coupling of the user interface with the in-mold graphics film includes inserting the in-mold graphics film into a user interface injection mold and injecting a molten polymer into the injection mold to form the user interface about the in-mold graphics film. A touch sensitive component 112, 312 is positioned proximate to the user interface such that the touch sensitive component is capable of receiving touch communication through the user interface. The positioning of the touch sensitive component adjacent to the user interface includes releasably connecting the capacitive touch board 112, 312 to the holder. A holder 114, 314 is releasably connected to the user interface. The holder is configured to receive the touch sensitive component. According to one aspect of the exemplary method, the touch sensitive component 112, 312 is suitably sealed to a back surface of the user interface 110, 310 to restrict passage of fluid or prevent moisture therebetween. The method further comprises releasably connecting a controller 200, 350 to the holder 114, 314. The controller is in communication with the touch sensitive component to interpret a user's selection on the user interface.

It should be further understood that various exemplary embodiments of the present disclosure may be configured for use with a variety of touch sensitive components in addition to capacitive touch-screen assemblies. The various different types of touch sensitive components that may be used in conjunction with the user interfaces 110, 310 described herein may include, but are not limited to: resistive touch-screen assemblies; surface wave touch-screen assemblies; infrared touch-screen assemblies; strain gage touch-screen assemblies; optical imaging touch-screen; dispersive signal touch-screen assemblies; acoustic pulse recognition touch-screen assemblies; and combinations of such touch sensitive components.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A touch-screen interface for a dishwasher door, the touch-screen interface comprising:
a user interface including a graphics film defining a plurality of transparent portions, the user interface being configured to facilitate touch communication therethrough, the graphics film being secured to the user interface to prevent moisture therebetween;
a touch sensitive component configured to receive touch communication through the user interface, the touch sensitive component sensing a position of a user's finger on the user interface; and
a holder releasably connected to the user interface and configured to releasable secure the touch sensitive component to the user interface, the holder being releasably coupled to a dishwasher door,
wherein releasable connection between the components of the touch-screen interface allows for ease of disassembly and repair or replacement of the components.

2. The touch-screen interface according to claim 1, wherein the touch sensitive component is a capacitive touch board.

3. The touch-screen interface according to claim 2, wherein the capacitive touch board is sealed to the user interface.

4. The touch-screen interface according to claim 1, wherein the user interface including the graphics film are molded together as a unitary component.

5. The touch-screen interface according to claim 1, wherein the holder at least partially houses the touch sensitive component.

6. The touch-screen interface according to claim 1, further including a controller releasably coupled to the holder, the controller being in communication with the touch sensitive component to interpret a user's selection on the user interface and in communication with a main controller of the dishwasher.

7. The touch-screen interface according to claim 6, wherein the controller is housed within the holder.

8. The touch-screen interface according to claim 6, further including a digital display releasably connected to the controller, at least a portion of the digital display being received in a opening located on the touch sensitive component, the digital display communicating to the user through the user interface in response to the user activating the touch sensitive component.

9. The touch-screen interface according to claim 1, wherein the combined user interface and the graphics film minimizes dimensional tolerances for proper operation of the touch-screen interface and has a substantially constant thickness for preventing inadvertent activation of the touch sensitive component.

10. The touch-screen interface according to claim 9, wherein the combined user interface and graphics film has a thickness of about 0.115 inches to about 0.125 inches.

11. The touch-screen interface according to claim 9, wherein the combined user interface and graphics film has a thickness of about 0.145 inches to about 0.155 inches.

12. The touch-screen interface according to claim 1, wherein the touch sensitive component is suitably sealed to the user interface to prevent the presence of moisture therebetween.

13. The touch-screen interface according to claim 1, wherein the user interface includes at least one boss for connecting the user interface to the holder, the at least one boss extending through the touch sensitive component.

14. A method for forming a touch-screen interface for a dishwasher door, the method comprising:
providing an in-mold graphics film, the in-mold graphics film defining a plurality of transparent portions;
coupling a user interface with the in-mold graphics film such that the in-mold graphics film is integral with the user interface and the plurality of translucent portions extend through a thickness of the user interface;
positioning a touch sensitive component proximate to the user interface such that the touch sensitive component is capable of receiving touch communication through the user interface; and
releasably connecting a holder to the user interface, the holder being configured to receive the touch sensitive component.

15. The method according to claim 14, wherein the coupling of the user interface with the in-mold graphics film includes inserting the in-mold graphics film into a user interface injection mold and injecting a molten polymer into the injection mold to form the user interface about the in-mold graphics film.

16. The method according to claim 14, wherein the positioning of the touch sensitive component proximate to the user interface includes releasably connecting a capacitive touch board to the holder.

17. The method according to claim 14, further comprising sealing the touch sensitive component to a back surface of the user interface to prevent presence of moisture therebetween.

18. The method according to claim 14, further comprising releasably connecting a controller to the holder, the controller being in communication with the touch sensitive component to interpret a user's selection on the user interface.

19. A dishwasher door comprising:
a door structure; and
a touch-screen interface coupled to the door structure, the touch-screen interface including:
an in-mold graphics film defining a plurality of transparent portions;
a user interface coupled with the in-mold graphics film such that the in-mold graphics film is integral with the user interface and the plurality of translucent portions extend through a thickness of the user interface;
a touch sensitive component coupled to the user interface, the touch sensitive component being capable of receiving touch communication through the user interface, the thickness of the user interface preventing inadvertent activation of the touch sensitive component;
a holder releasably connected to the user interface, the holder being configured to receive the touch sensitive component; and
a controller releasably housed within the holder, the controller being in communication with the touch sensitive component to interpret a user's selection on the user.

20. The dishwasher door according to claim 19, wherein the touch sensitive component is sealed to the user interface to prevent presence of moisture therebetween.
